(19) United States
(12) Patent Application Publication
(10) Pub. No.: US 2006/0175436 A1
(43) Pub. Date: Aug. 10, 2006

(54) Fuel injection device

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/565,388

(22) PCT Filed: Jun. 9, 2004
(86) PCT No.: PCT/DE04/01199

§ 371 Date: Jan. 23, 2006

(30) Foreign Application Priority Data
Jul. 24, 2003 (DE) 103 33 695.8

(51) Int. Cl. F02M 63/00

(52) U.S. Cl. 239/533.2

(57) ABSTRACT

A fuel injection apparatus for supplying fuel to an injection valve from a high pressure line includes a control valve controlling pressure in a control chamber connected to the line and an actuator for moving a valve member to actuate via a hydraulic coupler having two pistons acting on a coupler volume, the seat of the valve member having an cross-sectional area f3 for filling the coupler volume with pressurized fuel via guidance gaps of the pistons. The pistons are guided one inside the other and a booster chamber at the ends of the pistons is oriented toward the actuator. A filling chamber inside the outer piston is connected to the line and one piston having a cross-sectional area f4 is mechanically coupled to the actuator by a rod with a cross-sectional area f5; the other piston has a piston area f2, and actuates the control valve via a second rod having a cross-sectional area f1 smaller than f2. The direction of the opening movement of the valve member coincides with the direction of fuel flowing out of the control chamber so that the control valve is at least partially force-balanced due to the pressure acting on the additional piston in the booster chamber.

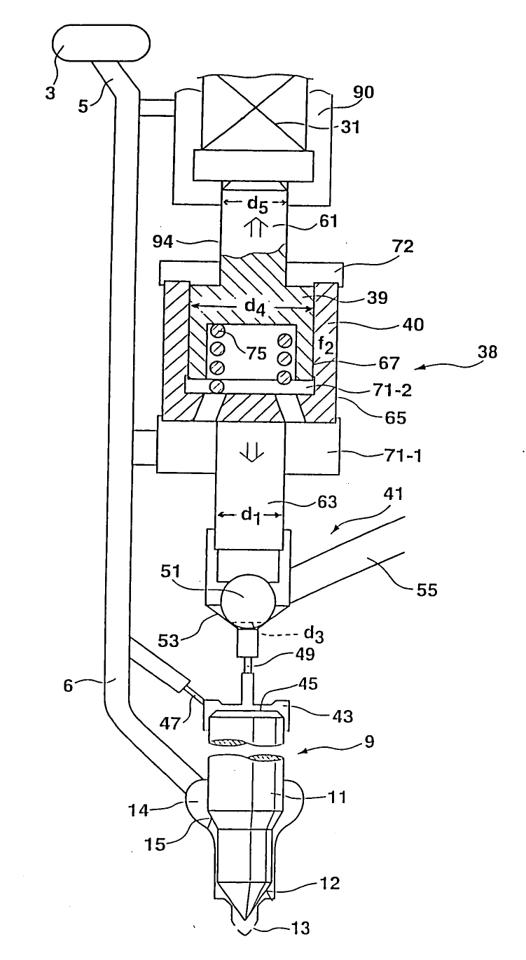

### PRIOR ART

The present invention is based on a fuel injection apparatus as generically defined by the preamble to claim 1.

A CR injector (CR=common rail) with a piezoelectric actuator and boosting by means of a hydraulic coupler is known. There are also known integrated couplers with pistons guided coaxially one inside the other. The known apparatus uses an O valve as a control valve. Because of possible cavitation, this valve must be produced with a particular shape, is expensive, and can only be embodied with a relatively small diameter since otherwise, the forces acting on the valve become too great for an actuation by means of a piezoelectric actuator.

### ADVANTAGES OF THE INVENTION

The fuel injection apparatus for internal combustion engines according to present invention, with the characterizing features of claim 1, has the advantage over the prior art that it creates a CR injector with a piezoelectric actuator in which the valve can have a large cross section and is embodied as an I valve. As a result, the opening and closing of the injection valve can occur more rapidly. The integrated coupler makes it possible to provide a short overall length for the apparatus. The coupler is assisted by CR pressure.

### DRAWING

An exemplary embodiment of the fuel injection apparatus according to present invention is shown in the drawing and will be explained in greater detail in the description below.

The sole FIGURE shows the essential components of a fuel injection apparatus according to present invention, having an injection valve and a control valve as well as a hydraulic coupler.

### DESCRIPTION OF THE EXEMPLARY EMBODIMENT

The fuel injection apparatus 1 according to present invention is supplied with highly pressurized fuel from a pressure reservoir (common rail) 3 via a high-pressure line 5 from which fuel travels via an injection line 6 to an injection valve 9. An internal combustion engine usually has a number of such injection valves, but for the sake of simplicity only one of them is shown. The injection valve 9 has a valve needle (valve piston, nozzle needle) 11 whose conical valve sealing surface 12, when in its closed position, closes injection openings 13 through which fuel is to be injected into the interior of a combustion chamber of the engine. The fuel travels into the region of the nozzle needle via an annular nozzle chamber 14 from which it is able to exert a pressure in the opening direction of the nozzle needle by means of a control surface 15 embodied in the form of a pressure shoulder. When this pressure exerts a force on the needle in the opening direction that exceeds the forces counteracting this opening, then the valve opens.

An actuator 31 serves to control the opening and closing of the injection openings. In response to being triggered, this actuator 31 produces a deflection at a mechanical outlet and generates a force for actuating other elements. In the example, it is an electrically triggered actuator equipped with a piezoelectric element, namely a piezoelectric actuator. In response to an electrical triggering, the actuator assumes a configuration that is elongated or shortened in the vertical direction in the drawing and therefore in its longitudinal direction. In the example, an actuator is provided with a design of the type that assumes an elongated configuration when supplied with current (connection to a direct current supply), and assumes a shortened configuration when without current. The actuator constitutes a capacitive load and does not absorb any power loss when supplied with constant current. It can be advantageous or necessary to prestress the piezoelectric actuator by means of a clamping device, e.g. a spring, so that piezoelectric elements contained in the actuator are always subjected to pressure. This is known to those skilled in the art and will therefore not be discussed in detail below. Whereas the upper end of the piezoelectric actuator is anchored in the injection device in a manner not shown in the drawing, the lower end of the piezoelectric actuator serves to use its force and movement to, in the end, open and close the injection openings. To this end, the piezoelectric actuator is coupled by means of a hydraulic coupler 38, which has a piston 39 coupled to the piezoelectric actuator and an additional piston 40. In the current instance, it is generally necessary for the coupler to achieve an increase in the distance traveled by the additional piston 40 in comparison to the distance traveled by the piston 39 (through appropriate selection of the hydraulically effective piston surfaces). The design and operation of the hydraulic coupler will be described further below. The piezoelectric actuator constitutes a capacitive load and therefore does not absorb any constant current.

When the piston 40 of the hydraulic coupler not directly connected to the piezoelectric actuator opens a control valve 41 (or outlet valve), the pressure drops in a fuel-filled control chamber 43 that is engaged by the upper end section of the nozzle needle. The control chamber 43 is filled with pressurized fuel via an inlet throttle 47 and when the control valve 41 is open, fuel flows out of the control chamber 43 via an outlet throttle 49. The outflow of fuel is assisted by forces that act on the nozzle needle 11 in the direction of its open position. A movable valve member 51, which is mechanically coupled to the piston 40, rests against a valve seat 53 in a sealed fashion when the control valve 41 is closed. When the valve member 51 is open, the control quantity that flows out of the control chamber is drained by means of a leakage conduit 55. When the valve member 51 is closed, it is subjected to rail pressure (=the pressure in the line 5) from the control chamber; the pressure acts on the area with the diameter d3.

The pistons 39 and 40 in the example are situated parallel to each other and one inside the other in a coaxial orientation that is advantageous from a production engineering standpoint (integrated coupler). The manner in which they are coupled to each other will be explained below. An arrow is drawn inside the piston 39 and indicates the movement of this piston when the actuator executes a movement in the downward direction in the drawing. An arrow is drawn inside the piston 40 and indicates the movement of this piston when the piston 39 executes the movement indicated by its arrow. By comparing the arrow of the piston 40 to the direction in which the movable valve member of the valve to be actuated by the hydraulic converter 38 must be moved in order to open or close, it is immediately clear from the drawing whether the above-mentioned arrows in the drawing correspond to an opening motion or a closing motion of the above-mentioned valve.

The movable valve member 51 is embodied as essentially ball-shaped. In particular, when closed, it rests against the valve seat 53 with an essentially dome-shaped surface region. In the example, a force must be exerted on the movable valve member 51 to press it against its valve seat so that it prevents the escape of the pressurized fuel from the control chamber 43. The valve member 51 is thus in the closed state when the movable valve member has been moved “inward” into its closed position, namely in the direction from a lower pressure region to a higher pressure region, and therefore, the control valve in the current instance is referred to as an I valve. In other words, the direction of the opening movement of the movable valve member coincides with the direction of fuel flowing out of the control chamber. By contrast, a valve whose movable valve member has been moved “outward” into its closed position, namely in the direction from the high pressure in the control chamber toward a lower pressure region of leakage pressure is referred to as an O valve.

The above-mentioned ball valve can have a free-floating ball without a rigid connection to another part. Because of its flow-favorable shape, a ball is not very susceptible to cavitation. In lieu of this, it is also possible to use another suitable construction for the I valve, e.g. a conical valve with a conical surface region that cooperates with the valve seat. The valve member here can be rigidly connected to the associated piston to permit a particularly rapid opening of the control valve.

The actuator 31 is connected to the piston 39 by means of a rod 61 with a diameter d5. A rod 63 with a diameter d1 connects the piston 40 to the movable valve member 51 that it is to actuate. The inner piston 39 has a diameter d4 and the outer piston 40 has a circular ring-shaped piston surface with a width f2. The inner diameter of the valve seat 53 at which the movable valve member rests against it is d3.

Guidance gaps 65 and 67, which serve to guide the pistons in a sliding fashion and through which a coupler volume is filled with fuel, are embodied in the region of the cylindrical outer surface of the outer piston (in relation to a housing not shown) and in the region of the reciprocal sliding guidance between the two pistons.

The above-mentioned area f2 as well as the areas f1 and f3 through f5 that correspond to the above-mentioned diameters (for circular cross sections) are decisive for the function. Circular cross sections are in fact useful from a manufacturing standpoint, but the invention is not limited to them.

The end regions of the pistons 39 and 40 oriented toward the actuator 31 engage a shared booster chamber 72. The other end of the piston 39 engages a filling chamber 71-2 that is connected via bores in the bottom end wall of the piston 40, which is connected to the line 5. The other end region of the inner piston 40 protrudes into the filling chamber 71-2. The booster chamber 72 is filled via the guidance gaps 65 and 67. The rod 61 passes through the booster chamber 72. The rod 63 passes through the filling chamber 71-1. The pistons 39 and 40 move in opposite directions and, because of the boosting of the desired travel distance, move away from the actuator and toward the control valve at different speeds.

In the closed state of the injection valve 9, the actuator 31 (piezoelectric actuator) is without current and shortened. In order to open the control valve 41, the electrical current to the actuator 31 is switched on and the actuator becomes longer. This moves the piston 39 (first booster piston) downward in the drawing. In the idle state, CR pressure (=pressure in the pressure accumulator or common rail) prevails as the system pressure in the booster chamber 72 and in the filling chamber 71-2. The downward movement of the piston 39 reduces the pressure in the booster chamber 72. This pressure decrease moves the piston 40 (second booster piston) upward and, through a movement of the valve member 51 in the same direction, opens the control valve 41, which is an I valve. For particularly rapid opening of the valve member 51, in some embodiment forms of the present invention, this valve member 51 can be attached to the rod 63 and therefore to the piston 40. Due to the CR pressure in the booster chamber 72, the seat diameter d3 of the valve member 51 can be selected to be very large since the piston 40 largely compensates for this area with its end situated in the booster chamber 72. When the valve 41 closes, the upward movement of the piston 39 is assisted by the spring 75 and by the pressure in the filling chamber 71-2. The present invention consequently creates an advantageous I valve servo injector with CR pressure assistance for very rapid opening and closing of the injection valve. The coaxial coupler yields a short overall length.

An important feature of the present invention lies in the fact that rail pressure is exerted at the end of the piston 39 (in the booster chamber) oriented away from the control valve, which rail pressure assists the actuation of the control valve and counteracts the pressure that the control chamber 43 exerts on the valve member 51 in the closed state.

Because of the rail pressure in the booster chamber 72, the diameter d3 is largely force-balanced. In comparison to the prior art, therefore, there is a greater excess of actuator-generated force available for accelerating the mass of the movable valve member. The present invention consequently creates a variant having a partially balanced control valve (=partially balanced in terms of the force) in which the valve is an I valve. This means that the actuator does not have to supply as powerful a force as in the prior art in order to close the valve. In lieu of this, one embodiment form has a valve 51 with a diameter d3 larger than in the known one, which permits a more rapid opening and closing of the injection valve because the flow intake and output are greater in it than in the smaller O valve known from the prior art. A compression spring 75 in the filling chamber 71-2 pushes the pistons away from each other and assures a good contact of the coupler against the actuator 31 and, when the valve is closed, assures a good contact of the valve member 51 against the valve seat 53.

The apparatus described up to this point has additional features. At least in a region of the rod 61 that connects the actuator 31 to the hydraulic coupler, spaced apart from the coupler chamber situated the closest to the actuator 31, there is an additional filling chamber 90 that is connected to the line 5. In the example, the additional filling chamber 90 encompasses the actuator 31 in its lower end region. Preferably, it encompasses the entire actuator 31. A guidance gap 94 of the rod 61 is dimensioned to permit an additional filling of the adjacent chamber of the coupler with pressurized fuel. The additional filling of the coupler with highly pressurized fuel constitutes an advantage.

In some embodiment forms of the present invention, the additional filling chamber 90 is not provided or is not connected to the line 5 and does not have the function of the filling chamber. In this case, it can be suitable for a bore in which the rod 61 is guided in a housing of the entire apparatus, not shown, to be dimensioned so as to permit the least possible leakage of fuel from the coupler.

The present invention also includes embodiment forms in which the highly pressurized fuel is not supplied from a high-pressure reservoir, but from a pump that is associated with the injection valve (e.g. unit injectors) and also feeds the filling chamber.

1-2. (canceled)

3. In a fuel injection apparatus having an injection valve including a control chamber, having a line that supplies highly pressurized fuel to the injection valve during operation, having an actuator and having a control valve that controls the pressure in the control chamber of the injection valve connected to the line and includes a movable valve member that the actuator is able to actuate via a hydraulic coupler, the hydraulic coupler having two pistons that cooperate with a coupler volume of the coupler, the seat of the movable valve member having an internal cross-sectional area f3 equipped with means for filling the coupler volume with pressurized fuel via guidance gaps of the pistons, the improvement comprising a booster chamber at the ends of the pistons oriented toward the actuator, the pistons being guided one inside the other in parallel fashion; a filling chamber inside the outer piston and connected to the line; a rod mechanically coupling one of the pistons to the actuator, the rod having a cross-sectional area f5; the other piston actuating the control valve by means of a second rod, the second rod having a cross-sectional area f1 smaller than f2; the direction of the opening movement of the movable valve member coinciding with the direction of fuel flowing out of the control chamber so that the control valve is at least partially force-balanced due to the pressure acting on the additional piston in the booster chamber.

4. A fuel injection apparatus according to claim 3, further comprising an additional filling chamber at least in a region of the rod connecting the actuator to the hydraulic coupler and spaced apart from the coupler chamber situated the closest to the actuator, the additional filling chamber being connected to the line 5 and communicating with the coupler via a guidance gap of the rod.
